(19) United States
(12) Patent Application Publication
(10) Pub. No.: US 2018/0323899 A1
(43) Pub. Date: Nov. 8, 2018

(54) HTTP ADAPTIVE STREAMING SERVER, METHOD, AND CLIENT TERMINAL BASED ON NETWORK ENVIRONMENT MONITORING

(71) Applicant: Samsung Electronics Co., Ltd., Suwon-si (KR)

(72) Inventors: Dae-Kyu CHOI, Suwon-si (KR); Yong-Woo NAM, Bucheon-si (KR); Hyeon-Hun JUNG, Suwon-si (KR); Sum HWANG, Suwon-si (KR)

(21) Appl. No.: 15/962,605

(22) Filed: Apr. 25, 2018

(30) Foreign Application Priority Data
May 2, 2017 (KR) 10-2017-0056110

(51) Int. Cl. H04L 1/00; H04L 29/06; H04L 29/08

(52) U.S. Cl. CPC H04L 1/0002; H04L 65/4069; H04L 5/0055; H04L 67/02; H04L 65/608

(57) ABSTRACT

The disclosure relates to a communication technique for combining a 5th generation (5G) communication system that supports higher data transmission rates after 4th generation (4G) systems with Internet of Things (IoT) technology and to system thereof. The disclosure can be applied for intelligent services based on 5G communication technology and IoT related technology (e.g., smart homes, smart buildings, smart cities, smart cars or connected cars, healthcare, digital education, retail businesses, security and safety related services, and the like). To do so, a method for providing, by a streaming server, HTTP adaptive streaming to a client terminal is provided. The method includes transmitting a first multimedia data to a terminal, monitoring a network environment between a streaming server and the terminal when the first multimedia data is transmitted to the terminal, and pushing at least one second multimedia data based on the network environment monitored.

### CROSS-REFERENCE TO RELATED APPLICATION(S)

This application is based on and claims priority under 35 U.S.C. § 119(a) of Korean patent application number 10-2017-0056110, filed on May 2, 2017, in the Korean Intellectual Property Office, the disclosure of which is incorporated by reference herein in its entirety.

### TECHNICAL FIELD

The disclosure relates to hypertext transfer protocol (HTTP) adaptive streaming servers, methods, and client terminals.

### BACKGROUND

In order to meet the demand for wireless data traffic that has increased significantly since the 4th generation (4G) communication system came to the market, there are ongoing efforts to develop enhanced 5th generation (5G) communication systems or pre-5G communication systems. For these and other reasons, the 5G communication system or pre-5G communication system is typically called the beyond 4G network communication system or post long term evolution (LTE) system.

For higher data transmit rates, 5G communication systems are to be implemented on ultra high frequency bands (mmWave), such as, e.g., 60 GHz. To mitigate pathloss on the ultra high frequency band and increase the reach of radio waves, the following techniques are being taken into account for the 5G communication system: beamforming, massive multi-input multi-output (MIMO), full dimensional MIMO (FD-MIMO), array antenna, analog beamforming, and large-scale antenna.

Also being developed are various technologies for the 5G communication system to have an enhanced network, such as evolved or advanced small cell, cloud radio access network (cloud RAN), ultra-dense network, device-to-device (D2D) communication, wireless backhaul, moving network, cooperative communication, coordinated multi-point (CoMP), and interference cancellation.

There are also other various schemes under development for the 5G system including, e.g., hybrid frequency-shift keying (FSK) and quadrature amplitude modulation (QAM) modulation (FQAM) and sliding window superposition coding (SWSC), which are advanced coding modulation (ACM) schemes, and filter bank multi-carrier (FBMC), non-orthogonal multiple access (NOMA) and sparse code multiple access (SCMA), which are advanced access schemes.

Meanwhile, the Internet is evolving from a human-centered connection network by which humans create and consume information, into an Internet of Things (IoT) network by which information is communicated and processed between things or other distributed components. The Internet of Everything (IoE) technology is an example of a combination of big data processing technology and the IoT technology through, e.g., a connection with a cloud server.

To implement the IoT, technology elements, such as a sensing technology, wired/wireless communication and network infra, service interface technology, and security technology, are required. There is also recent ongoing research for other inter-object connection technologies, such as a sensor network, machine-to-machine (M2M), or machine-type communication (MTC).

In the IoT environment, intelligent Internet technology (IT) services may be offered that collect and analyze data generated by things connected with one another to create a new value. The IoT may have various applications, such as a smart home, a smart building, a smart city, a smart car or a connected car, a smart grid, health-care, smart appliance industry, or state-of-the-art medical services, through conversion or integration of existing IT technologies and various industries.

Thus, there are various ongoing efforts to apply the 5G communication system to the IoT network. For example, the sensor network, M2M, machine type communication (MTC), or other 5G techniques are being implemented by schemes, such as beamforming, MIMO, and array antenna schemes. The above-mentioned application of the cloud radio access network as a big data processing technique may also be said to be an example of the convergence of 5G and IoT technologies.

Adaptive streaming is a technique for adaptively selecting an adequate video quality considering the environment of the network and client terminal, which is required to meet the quality that users experience in a varied wireless network environment. Such adaptive streaming is applied based on various network protocols, such as the real-time transport protocol (RTP) or real-time streaming protocol (RTSP). Recently attracting attention are hypertext transfer protocol (HTTP) adaptive streaming techniques using the HTTP.

HTTP adaptive streaming may adopt existing HTTP technology, advancing network compatibility for streaming services and advantageously allowing for reuse of existing HTTP services for streaming services. Further, HTTP adaptive streaming puts the core of streaming controls with the client, thus being able to provide streaming services to clients to receive services.

FIG. 1 is a view illustrating an example of communication between a client and a server in an HTTP adaptive streaming technique according to the related art.

In the HTTP adaptive streaming technique, a client terminal receives one data segment (e.g., response_1 of FIG. 1) from a streaming server each time the client terminal sends a request (e.g., request_1 of FIG. 1) for one data segment. Thus, the client terminal needs to send out as many request messages as the number of data segments, causing an accumulation of request messages over time and hence overloading the client terminal, streaming server, and the network.

The above information is presented as background information only, and to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages, and to provide at least the advantages described below. Accordingly, an aspect of the disclosure is to provide a streaming server, a client terminal, a streaming system, and a method using a hypertext transfer protocol (HTTP) adaptive streaming scheme based on network environment monitoring.

Another aspect of the disclosure is to provide a scheme for relieving a client terminal, a streaming server, and a streaming system of overload in running HTTP adaptive streaming.

Another aspect of the disclosure is to provide a scheme for providing streaming data that adaptively varies depending on variations in the network environment.

In accordance with another aspect of the disclosure, a method for providing, by a streaming server, HTTP adaptive streaming to a client terminal is provided. The method includes transmitting a first multimedia data item to the client terminal, monitoring a network environment between the streaming server and the client terminal when the first multimedia data item is transmitted to the client terminal, and pushing at least one second multimedia data item based on the monitored network environment.

In accordance with another aspect of the disclosure, pushing may include further transmitting the at least one second multimedia data item to the client terminal regardless of whether there is a request from the client terminal after the streaming server transmits the first multimedia data item to the client terminal.

In accordance with another aspect of the disclosure, pushing may include further transmitting the at least one second multimedia data item to the client terminal at predetermined times.

In accordance with another aspect of the disclosure, the predetermined times may be determined based on the first multimedia data item, the number of the at least one second multimedia data item, or a playing duration.

In accordance with another aspect of the disclosure, the network environment may be a transmission rate between the streaming server and the client terminal. Monitoring may include calculating the transmission rate based on a difference between a time of starting transmission of the first multimedia data item and a time of ending the transmission of the first multimedia data item.

In accordance with another aspect of the disclosure, the difference may be determined as a difference between the time of starting the transmission of the first multimedia data item and a time of receiving an acknowledgment (ACK) signal for the first multimedia data item transmitted.

In accordance with another aspect of the disclosure, the first multimedia data item may include video data or audio data split into segments.

In accordance with another aspect of the disclosure, pushing may include further transmitting the at least one second multimedia data item with a resolution different from a resolution of the first multimedia data item.

In accordance with another aspect of the disclosure, pushing may include further transmitting the at least one second multimedia data item with a resolution lower than the resolution of the first multimedia data item when the calculated transmission rate is lower than a prior transmission rate.

In accordance with another aspect of the disclosure, pushing may include further transmitting the at least one second multimedia data item with a resolution lower than the resolution of the first multimedia data item when the calculated transmission rate is lower than a transmission rate corresponding to the resolution of the first multimedia data item.

In accordance with another aspect of the disclosure, a streaming server configured to provide HTTP adaptive streaming to a client terminal is provided. The streaming server includes a server communicator configured to transmit a first multimedia data item to the client terminal, and a server controller configured to control to monitor a network environment between the streaming server and the client terminal when the first multimedia data item is transmitted to the client terminal and push at least one second multimedia data item based on the network environment being monitored.

In accordance with another aspect of the disclosure, pushing may include further transmitting the at least one second multimedia data item to the client terminal regardless of whether there is a request from the client terminal after the streaming server transmits the first multimedia data item to the client terminal.

In accordance with another aspect of the disclosure, the server controller may be configured to further transmit the at least one second multimedia data item to the client terminal at predetermined times.

In accordance with another aspect of the disclosure, the predetermined times may be determined based on the first multimedia data item, the number of the at least one second multimedia data item, or a playing duration.

In accordance with another aspect of the disclosure, the network environment may be a transmission rate between the streaming server and the client terminal.

In accordance with another aspect of the disclosure, the server controller may be configured to calculate the transmission rate based on a difference between a time of starting transmission of the first multimedia data item and a time of ending the transmission of the first multimedia data item.

In accordance with another aspect of the disclosure, the difference may be determined as a difference between the time of starting the transmission of the first multimedia data item and a time of receiving an ACK signal for the first multimedia data item transmitted.

In accordance with another aspect of the disclosure, the first multimedia data item may include video data or audio data split into segments.

In accordance with another aspect of the disclosure, the server controller may be configured to push the at least one second multimedia data item with a resolution different from a resolution of the first multimedia data item.

In accordance with another aspect of the disclosure, the server controller may be configured to push the at least one second multimedia data item with a resolution lower than the resolution of the first multimedia data item when the calculated transmission rate is lower than a prior transmission rate.

In accordance with another aspect of the disclosure, the server controller may be configured to push the at least one second multimedia data item with a resolution lower than the resolution of the first multimedia data item when the calculated transmission rate is lower than a transmission rate corresponding to the resolution of the first multimedia data item.

In accordance with another aspect of the disclosure, a client terminal configured to receive HTTP adaptive streaming from a streaming server is provided. The client terminal includes a terminal communicator configured to receive a first multimedia data item from the streaming server and a terminal controller configured to calculate a parameter value regarding a network environment between the streaming server and the client terminal when the first multimedia data item is transmitted to the terminal communicator and send a request for at least one second multimedia data item to be received by pushing to the streaming server based on the calculated parameter value.

In accordance with another aspect of the disclosure, the parameter value regarding the network environment may be calculated based on a difference between a time when the first multimedia data item is transmitted from the streaming server and a time when the first multimedia data item is received by the client terminal.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an example of communication between a client and a server in a hypertext transfer protocol (HTTP) adaptive streaming technique according to the related art;

FIG. 2 is a view illustrating a streaming system to provide HTTP adaptive streaming by monitoring a network environment according to an embodiment of the disclosure;

FIG. 3 is a flowchart illustrating a method for providing HTTP adaptive streaming by monitoring a network environment according to an embodiment of the disclosure;

FIG. 4 is a view illustrating an example of a method for providing HTTP adaptive streaming by monitoring a network environment as shown in FIG. 3, according to an embodiment of the disclosure;

FIG. 5 is a flowchart illustrating a method for providing HTTP adaptive streaming by monitoring a network environment according to an embodiment of the disclosure;

FIG. 6 is a view illustrating an example of a method for providing HTTP adaptive streaming by monitoring a network environment as shown in FIG. 5, according to an embodiment of the disclosure;

FIG. 7 is a flowchart illustrating a method for providing HTTP adaptive streaming by monitoring a network environment according to an embodiment of the disclosure;

FIG. 8 is a block diagram illustrating a streaming server according to an embodiment of the disclosure;

FIG. 9 is a block diagram illustrating a client terminal according to an embodiment of the disclosure; and

FIG. 10 is a block diagram illustrating a streaming system according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used to enable a clear and consistent understanding of the disclosure. Accordingly, it should be apparent to those skilled in the art that the following description of various embodiments of the disclosure is provided for illustration purpose only, and not for the purpose of limiting the disclosure as defined by the appended claims and their equivalents.

The terms “first” and “second” as used herein may be used to describe various components, but the components should not be limited by the terms. The terms are used only to distinguish one component from another. When an element “includes” another element, the element may further include the other element, rather excluding the other element, unless particularly stated otherwise. As used herein, the term “unit” means a software element or a hardware element such as a field-programmable gate array (FPGA) or an application specific integrated circuit (ASIC). A unit plays a certain role. However, the term “unit” is not limited as meaning a software or hardware element. A “unit” may be configured in a storage medium that may be addressed or may be configured to reproduce one or more processors.

It is to be understood that the singular forms “a,” “an,” and “the” include plural referents unless the context clearly dictates otherwise. Thus, for example, reference to “a component surface” includes reference to one or more of such surfaces.

Accordingly, as an example, a “unit” includes elements, such as software elements, object-oriented software elements, class elements, and task elements, processes, functions, attributes, procedures, subroutines, data segments of program codes, drivers, firmware, microcodes, circuits, data, databases, data architectures, tables, arrays, and variables. A function provided in an element or a “unit” may be combined with additional elements or may be split into sub elements or sub units.

As used herein, “transmission rate” may also be represented as a data transmission rate, bitrate, or transfer rate, which may mean the amount of information transmitted per unit time, the speed at which data is transmitted, or the number of bits (bits/sec or bps) processed per particular time unit (e.g., second).

According to the present disclosure, there are proposed a streaming server, a client terminal, a streaming system, and a method for providing hypertext transfer protocol (HTTP) adaptive streaming based on the results of monitoring the network environment between a streaming server and a client terminal.

FIG. 2 is a view illustrating a streaming system to provide HTTP adaptive streaming by monitoring a network environment according to an embodiment of the disclosure.

Referring to FIG. 2, a streaming system 200 includes a streaming server 220 and a client terminal 210. The streaming server 220 is an entity to provide media data, e.g., video, over the network by communicating with the client terminal 210. The client terminal 210 is an entity to receive media data, e.g., video, by communicating with the streaming server 220, and which may also be referred to as a terminal, mobile terminal, user equipment (UE), mobile station (MS), mobile equipment (ME), or device.

The streaming server 220 may store multimedia data that may be provided to the client terminal 210. The multimedia data may include video data or audio data. Further, the multimedia data may also denote a data segment described below. The streaming server 220 may temporarily store multimedia data obtained through wired/wireless communication with sources that are outside of the streaming server 220.

The streaming server 220 may split the multimedia data into a plurality of data segments and store the data segments. The data segments may also be referred to as “chunks”. The plurality of data segments stored in the streaming server 220 may be subject to different conditions for, e.g., playing duration (e.g., 1 second, 10 seconds, or 1 minute), playing timing (e.g., 00:04:30 or 01:42:15), resolution (e.g., 480p, 720p, or 1080p or high, med, or low), sound quality (e.g., 129 kbps, 192 kbps, or 320 kbps), or coding scheme (e.g., MPEG-TS, MPEG-4 ASP, or H.264/MPEG-4 AVC). Further, the streaming server 220 may store the file name, segment serial number, playing timing, playing duration, resolution, or other information about each data segment, with such pieces of information corresponding to each data segment.

The client terminal 210 may produce a control environment, e.g., a user interface (UI), that enables the selection of multimedia data to be played. The UI that the client terminal 210 produces may provide for example, a list of multimedia data in the streaming server 220, a window for selecting a resolution of video data, and a window for selecting a sound quality of audio data. The UI may be provided to the user of the client terminal 210 through a screen of the client terminal 210.

Upon receiving a selection of multimedia data through the UI, the client terminal 210 may send a request for transmitting the selected multimedia data to the streaming server 220. The request of the client terminal 210 may include information about multimedia data that the client terminal 210 is to receive. The information about the multimedia data may include the name, data segments, and bitrate of the multimedia data. When the streaming server 220 delivers a corresponding image through wired/wireless communication, the client terminal 210 may display the received image. The UI which the client terminal 210 executes may also include a function of providing a control environment to control the playing timing, resolution, or sound quality of the multimedia data that is playing or to play new multimedia data.

The client terminal 210 and the streaming server 220 may communicate with each other through wired/wireless communication. The wired communication may include, e.g., universal serial bus (USB), high definition multimedia interface (HDMI), recommended standard (RS)-232, or plain old telephone service (POTS). The wireless communication may include, e.g., Bluetooth communication, Bluetooth low energy (BLE) communication, near-field communication (NFC), wireless local area network (WLAN) communication, ZigBee communication, infrared data association (IrDA) communication, wireless-fidelity (Wi-Fi) direct (WFD) communication, ultra-wideband (UWB) communication, Ant+ communication, Wi-Fi communication, 3rd generation (3G), 4th generation (4G), and 5th generation (5G) communication.

Upon receipt of a request for executing multimedia data through the UI, the streaming server 220 may transmit a predetermined number of data segments to the client terminal 210. The predetermined number may be previously determined by the user or processor, arbitrarily or as per a criterion, or based on the network environment between the streaming server 220 and the client terminal 210.

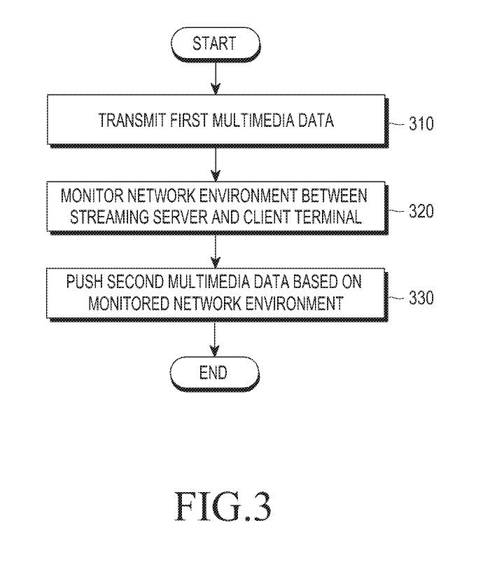

The streaming server 220 may select a data segment to be transmitted based on the network environment between the streaming server 220 and the client terminal 210 and transmit the selected data segment. This is described below in detail with reference to FIGS. 3 to 6.

FIG. 3 is a flowchart illustrating a method for providing HTTP adaptive streaming by monitoring a network environment according to an embodiment of the disclosure.

Referring to FIG. 3, upon receipt of a request for multimedia data from the client terminal, the streaming server transmits a predetermined number of data segments (e.g., “n” data segments) to the client terminal at operation 310. The predetermined number “n” may be set by the user or developer of the client terminal or the controller (or at least one processor) of the streaming server.

When a predetermined number “n” of data segments are transmitted to the client terminal, the streaming server calculates, e.g., monitors, parameter values regarding the network environment between the streaming server and the client terminal based on, e.g., a total size (e.g., total data volume) of the “n” data segments transmitted from the streaming server to the client terminal, and the time for the streaming server to transmit the “n” data segments at operation 320.

For example, the streaming server may calculate a mean transmission rate (e.g., a parameter value regarding the network environment) for each data segment using Equation 1 below:

$$Mean transmission rate = \frac{Total size of data segments transmitted}{Time taken to transmit n data segments} \times \frac{1}{n} \qquad Equation 1$$

The streaming server may select a resolution of a data segment to be pushed to the client terminal based on the mean transmission rate calculated using Equation 1, and pushes at least one data segment having the selected resolution to the client terminal at operation 330. “Push” may mean that the streaming server automatically or periodically transmits data to the client terminal even with no additional request from the client terminal after the streaming server's first transmission to the client terminal in response to the request for data transmission from the client terminal to the streaming server.

As an example, where the mean transmission rate calculated using Equation 1 is lower than a prior (or first) transmission rate, the streaming server may push a data segment having a resolution lower than that of the data segment already transmitted to the client terminal. The reason to push the data segment having a lower resolution than that of the data segment previously sent is that continuing to push data segments having the same resolution despite a reduced transmission rate between the streaming server and the client terminal as compared with before, may cause a delay or buffering when the client terminal plays video data.

As another example, where the mean transmission rate calculated using Equation 1 is lower than a minimum mean transmission rate required for the client terminal to play, without delay, video data with a predetermined resolution, the streaming server may transmit to the client terminal the data segment regarding the video data having the lower resolution than the predetermined resolution.

Even where the streaming server is transmitting data segments to the client terminal, if the client terminal requests the streaming server to stop transmitting data segments, the streaming server may stop the transmission of data segments immediately or with a time gap regardless of the current proceeding step (or transmission step).

By the above-described streaming method, the streaming server may provide delay-free or buffering-free streaming services to the user by transmitting data segments adequate or appropriate for the actual network environment.

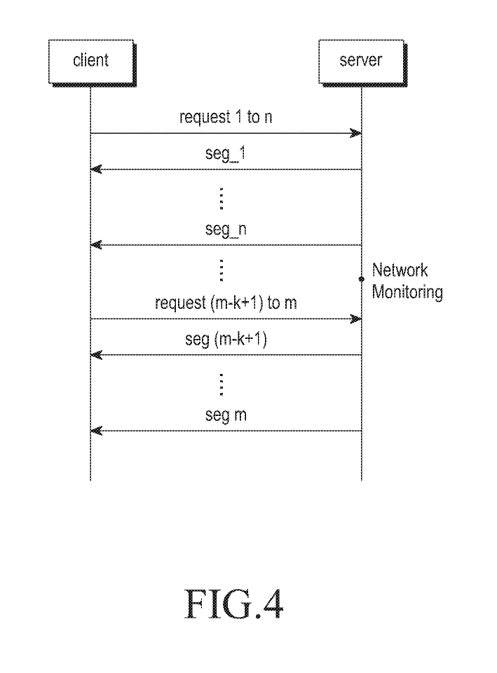

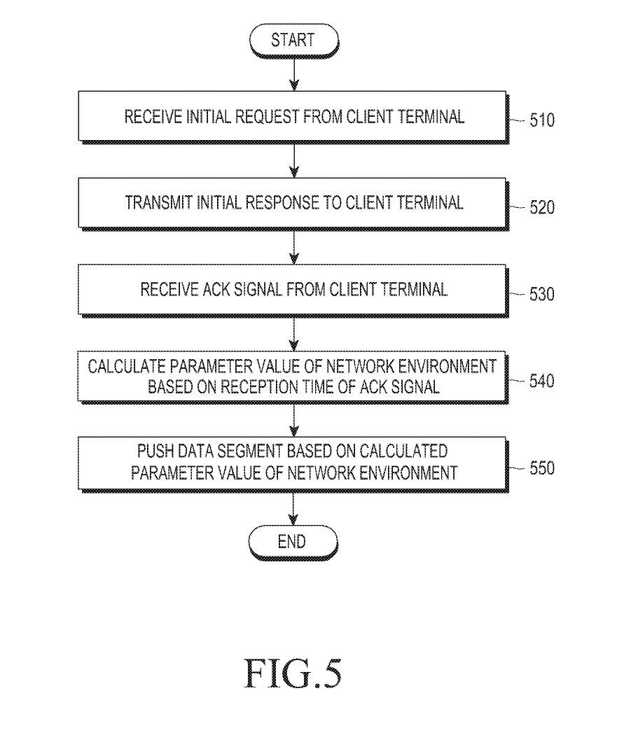

FIG. 4 is a view illustrating an example of a method for providing HTTP adaptive streaming by monitoring a network environment as shown in FIG. 3, according to an embodiment of the disclosure.

Referring to FIGS. 3 and 4, upon receipt of “n” requests (requests 1 to n of FIG. 4) for transmission of data segments from the client terminal, the streaming server transmits “n” data segments to the client terminal. The streaming server may transmit all of the “n” data segments (seg_1 to seg_n of FIG. 4) to the client terminal and calculate parameter values regarding the network environment between the streaming server and the client terminal while transmitting the “n” data segments to the client terminal, based on the size of the “n” data segments and the time to transmit the “n” data segments. The parameter values may be mean transmission rates calculated using Equation 1 above, and can be repeated for “m” requests.

As an example, where the mean transmission rate calculated using Equation 1 is lower than a prior transmission rate (e.g., the mean transmission rate between the streaming server and the client terminal upon transmitting seg_1 to seg_n), the streaming server may push a data segment having a resolution lower than that of the data segment already transmitted to the client terminal.

As another example, where the mean transmission rate that the streaming server calculated using Equation 1 above is lower than the transmission rate corresponding to the resolution of the data segment previously transmitted (e.g., a minimum transmission rate required for the video data corresponding to the previously transmitted segment to be played on the client terminal without delay), the streaming server may push data segments having a resolution lower than the data segment previously transmitted to the client terminal. For example, where the previously transmitted data segment has a resolution of 1080p (under the assumption that the transmission rate should be higher than a minimum of 3 Mpbs to play, without delay, videos with a resolution of 1080p), if the mean transmission rate calculated by Equation 1 is 2 Mbps, the streaming server may transmit data segments having a lower resolution (e.g., 480p or 720p) than the resolution (1080p) of the previously transmitted data segment to the client terminal.

As another example, where the mean transmission rate calculated using Equation 1 is higher than the prior (or before pushing) transmission rate or higher than the transmission rate corresponding to the resolution of the pre-transmitted data segment, the streaming server may keep the resolution of data segments to be pushed identical to the resolution of the pre-transmitted data segment, or as per a predetermined criterion or the user's selection entered to the client terminal, may transmit data segments having a higher resolution than the pre-transmitted data segment to the client terminal.

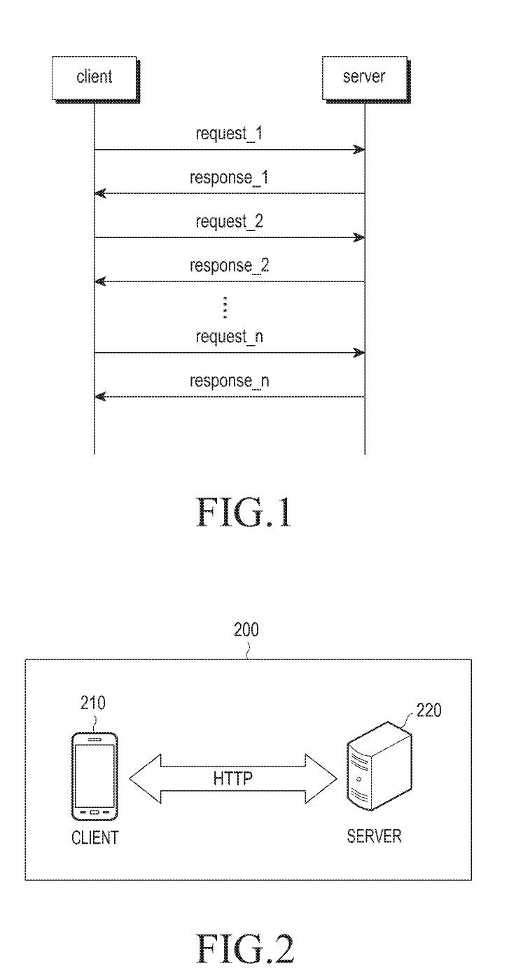

The scheme described in connection with FIG. 1 may disadvantageously overload the system because of the need for transmitting “n” requests to obtain “n” data segments. Yet, the method described above in connection with FIGS. 3 and 4 enables a plurality of segments to be pushed at one request, advantageously relieving the system of load.

FIG. 5 is a flowchart illustrating a method for providing HTTP adaptive streaming by monitoring a network environment according to an embodiment of the disclosure.

Referring to FIG. 5, the streaming server receives an initial request that the client terminal produces, from the client terminal based on the user's selection received through the UI at operation 510. The initial request may be, e.g., an HTTP request message. The initial request may contain at least one of a multimedia data name (video file name), bitrate, and segment serial number.

The streaming server produces an initial response corresponding to the initial request received from the client terminal and transmits the produced initial response to the client terminal at operation 520. Here, the initial response may be, e.g., an HTTP response message. The initial response may contain any one of the data segments of the multimedia data that the user has selected through the UI of the client terminal.

When the initial response reaches the client terminal, the client terminal produces an acknowledgment (ACK) signal and transmits the ACK signal to the streaming server at operation 530. The ACK signal may be an ACK code to notify that the initial response has arrived at the client terminal.

The streaming server calculates a parameter value, e.g., a transmission rate, regarding the network environment between the streaming server and the client terminal based on the size of the data segment transmitted to the client terminal and the time taken to transmit the data segment to the client terminal at operation 540. As an example, the streaming server may determine the network environment based on the difference between the time when the streaming server starts to transmit the data segment and the time when the ACK signal from the client terminal arrives at the streaming server. As a specific calculation scheme, Equation 2 may be used which stems from Equation 1. Equation 2 represents Equation 1 where the predetermined number “n” is 1.

$$Transmission rate = \frac{Size of data segment transmitted}{\begin{matrix}Reception time of ACK - \\ Start time of data transmission\end{matrix}} \qquad Equation 2$$

Since the streaming server calculates the parameter value (e.g., data transmission rate) regarding the network environment based on the time when the ACK signal from the client terminal is received by the streaming server, the streaming server may obtain a monitoring result precisely reflecting the environment in which the user actually receives support for streaming services.

The streaming server may push data segments of different states based on the parameter value (e.g., transmission rate) calculated using Equation 2 at operation 550. For example, where the transmission rate calculated using Equation 2 is lower than a prior transmission rate, the streaming server may push a data segment having a resolution lower than that of the data segment already transmitted to the client terminal. The resolution of data segments that the streaming server is to transmit to the client terminal may be varied stepwise or depending on the differences between the transmission rate calculated by Equation 2 and prior transmission rates.

As set forth above, in the method described in connection with FIG. 5 the network environment is monitored by the streaming server, not by the client terminal and therefore, the client terminal is less likely to be overloaded, enabling steady monitoring of the network environment. The client terminal, which is a common mobile terminal, e.g., a cellular phone, has limited battery life and CPU resources, requiring that the battery and CPU resources be used in an efficient way. The method disclosed in FIG. 5 may reduce resource consumption on the client terminal (e.g., a mobile terminal) by letting the streaming server monitor the network environment, allowing for efficient use of the resources of the client terminal.

The monitoring method described in connection with FIG. 5 and Equation 2 differs from the monitoring method described with reference with FIGS. 3 and 4 and Equation 1 as follows.

The monitoring method set forth with reference to FIGS. 3 and 4 and Equation 1 monitors the network environment after all of the “n” segments have been transmitted to the client terminal, and pushes other data segments based on a result thereof. In this case, before the transmission of all of the “n” data segments, the same data segments are forced to be transmitted despite a variation in the network environment, causing the waste of network bandwidth and resources of the streaming server and client terminal. However, the monitoring method described with reference to FIG. 5 and Equation 2 performs continuous monitoring of the network environment using an ACK corresponding to one push or initial response. This prevents the unnecessary waste of bandwidth or transmission resources that would result from the monitoring method of FIGS. 3 and 4 and Equation 1.

Where many network nodes are present between the streaming server and the client terminal and each network node retains many buffers, the mean transmission rate calculated using Equation 1 may be measured to be higher than the actual mean transmission rate. In this case, the user cannot receive the corresponding video data at proper speed, and a delay or buffering may occur in the video data. However, the monitoring method of FIG. 5 and Equation 2 performs monitoring while precisely reflecting the environment in which the user actually receives support for streaming services, thus avoiding or reducing a delay or buffering in the streaming video.

The method set forth with reference to FIGS. 3 and 4 requires that the client terminal send out a predetermined number of requests for data segments. However, the method described in connection with FIG. 5 differs in that only one segment request (e.g., an initial request) is needed.

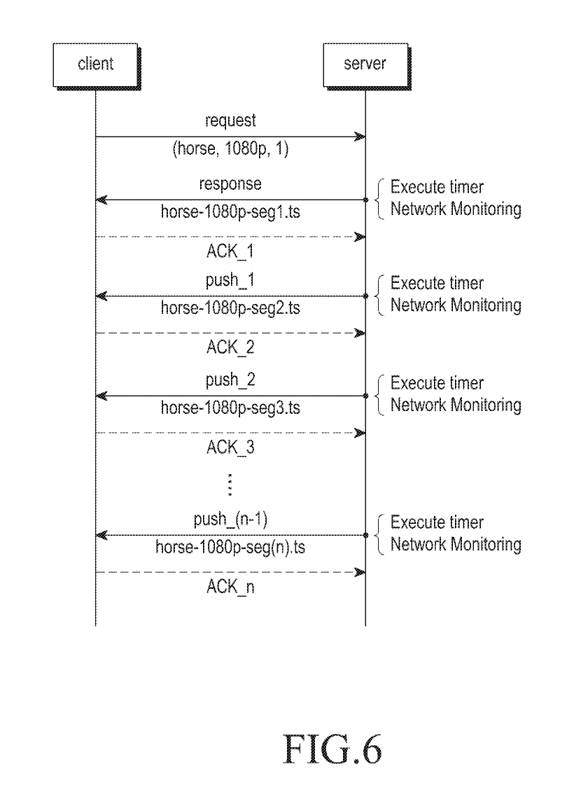

FIG. 6 is a view illustrating an example of a method for providing HTTP adaptive streaming by monitoring a network environment as shown in FIG. 5, according to an embodiment of the disclosure.

Referring to FIG. 6, when the client terminal receives a selection for multimedia data from the user through its UI, the client terminal may produce an initial request (request of FIG. 6) and transmit the initial request to the streaming server. Upon receipt of the initial request from the client terminal, the streaming server produces an initial response (response of FIG. 6) and transmits the initial response to the client terminal. When the initial response arrives at the client terminal, the client terminal may produce an ACK signal and transmit the ACK signal to the streaming server.

The streaming server may calculate the transmission rate using Equation 2 above, based on at least one of a size of the data segment transmitted to the client terminal or a time taken to transmit the data segment to the client terminal.

The streaming server may determine the state of the data segment to be pushed to the client terminal based on the calculated transmission rate and push the data segment corresponding to the determined state to the client terminal. Referring to FIG. 6, the streaming server may calculate the transmission rate when the streaming server transmits the response to the client terminal by applying Equation 2 and the difference between the time when the response is transmitted to the client terminal and the time of receipt of ACK_1, determine the state of the data segment to be transmitted as push_1 based on the calculated transmission rate, and push the data segment, as push_1, corresponding to the determined state to the client terminal. This rule may also be applicable to push_2 and push_(n−1) of FIG. 6.

Additionally, the streaming server may push data segments to the client terminal at each predetermined cycle using a timer (execute timer of FIG. 6). The streaming server may also transmit additional responses at each cycle using the timer and monitor the network environment (network monitoring of FIG. 6) using the ACK signal that the client terminal sends. The predetermined cycle may be set based on at least one the number and length of data segments.

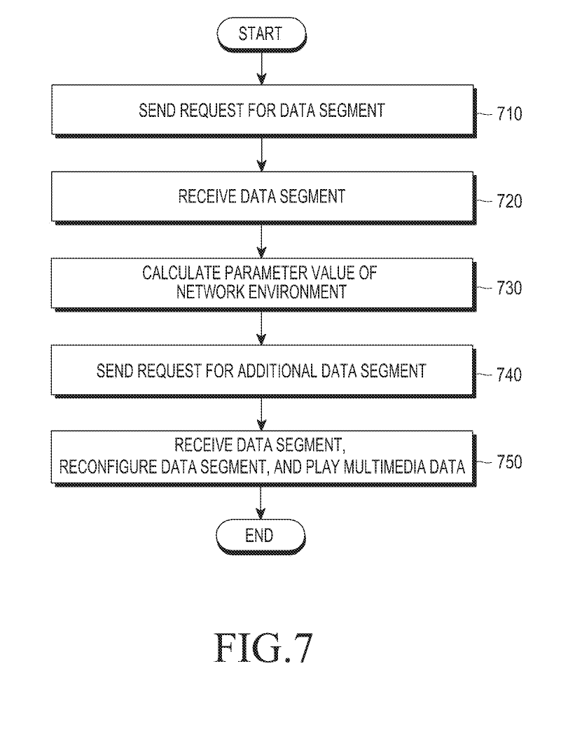

FIG. 7 is a flowchart illustrating a method for providing HTTP adaptive streaming by monitoring a network environment according to an embodiment of the disclosure.

Referring to FIG. 7, upon entry of multimedia data to be executed through the UI of the client terminal by the user, the client terminal sends a request for a data segment regarding the multimedia data to the streaming server at operation 710.

The client terminal receives the data segment that it requested from the streaming server at operation 720. Here, the data segment that the streaming server transmits, along with the time information about the time that the data segment is transmitted from the streaming server, may be transmitted to the client terminal.

During the course when the client terminal receives the data segment from the streaming server, the client terminal calculates a parameter value regarding the network environment between the client terminal and the streaming server at operation 730. Specifically, the client terminal may calculate the parameter value, e.g., data transmission rate, regarding the network environment between the client terminal and the streaming server using the size of the data segment transmitted and the difference between the time when the data segment is transmitted from the streaming server and the time when the data segment arrives at the client terminal.

The client terminal requests an additional data segment based on the calculated parameter value regarding the network environment at operation 740. For example, upon determining that the calculated data transmission rate is high, the client terminal may send a request for video data with a higher resolution, and upon determining that the calculated data transmission rate is low, the client terminal may send a request for video data with a lower resolution.

The client terminal may receive data segments from the streaming server. The data segment that the streaming server sends to the client terminal may be the one that the client terminal has requested the streaming server to transmit. The client terminal reconfigures and decodes the received data segment and plays the multimedia data that the user has selected at operation 750.

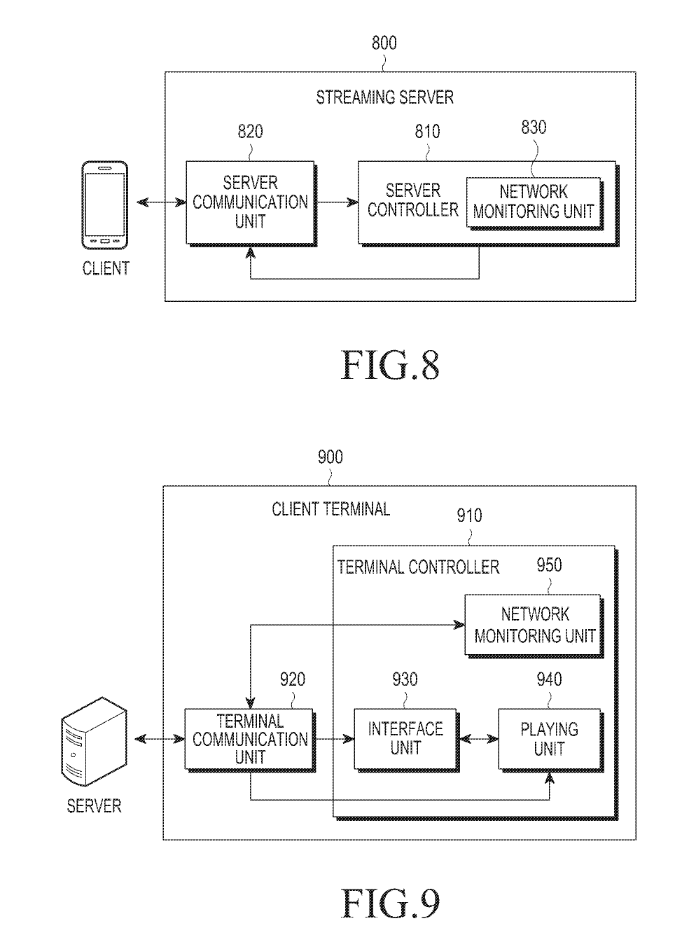

FIG. 8 is a block diagram illustrating a streaming server according to an embodiment of the disclosure.

Referring to FIG. 8, a streaming server 800 may include at least one of a sever controller 810 (or at least one processor) and a server communication unit 820 (or communicator or transceiver). The server controller 810 may include a network monitoring unit 830.

The streaming server 800 may further include a storage unit (not shown) for storing a plurality of multimedia data received from, and to be transmitted to a client terminal. The multimedia data may include at least one of video data and audio data.

The server controller 810 may split the multimedia data stored in the storage unit into a plurality of data segments. The plurality data segments split by the server controller 810 may be stored in the storage unit. As an example, the server controller 810 may split the video data stored in the storage unit at predetermined time intervals (e.g., every 10 seconds), compress them into a predetermined format (e.g., MPEG-TS) by an encoding process, and store them in the storage unit.

The streaming server 800 may still further include a temporary storage unit for temporarily storing and managing at least one of video data and audio data received from sources outside of the streaming server. Further, the server controller 810 may split multimedia data, which is obtained from sources outside of the streaming server 800 and temporarily stored in the temporary storage unit, into a plurality of data segments. For example, the server controller 810 may split one video data item into a plurality of data segments to which different conditions are applied for at least one of playing duration, playing timing, resolution, sound quality, or coding scheme.

The storage unit may store the plurality of data segments along with their respective data file names, serial numbers, start times, or lengths or one or more combinations thereof.

The server communication unit 820 is connected with the client terminal via wired/wireless communication. The server communication unit 820 may receive the request signal for multimedia data from the client terminal and transmit a plurality of data segments, which have been determined to be transmitted to the server controller 820, to the client terminal.

The server controller 810 may select a data segment based on, e.g., the type, time, image quality, or sound quality of multimedia data (e.g., video data or audio data) selected for the client terminal and transmit the selected data segment through the server communication unit 820 to the client terminal.

The server controller 810 may send a plurality of data segments to the client terminal even when the client terminal has sent a single request for data. This may diminish the number of requests that the client terminal is sends to the server and therefore, may also diminish the load on the client terminal, streaming server, and network due to transmission requests for streaming data.

The server controller 810 may further include the network monitoring unit 830. The network monitoring unit 830 may monitor the network environment between the streaming server 800 and the client terminal. For example, the network monitoring unit 830 may calculate the current transmission rate between the streaming server and the client terminal based on the size of the data segment transmitted to the client terminal and the time taken to transmit the data segment to the client terminal.

The streaming server 800 may further include a network logger (not shown). The network logger may produce, store, and manage logs containing records regarding the times of transmission and recommended data. The network monitoring unit 830 may also determine the network environment between the streaming server 800 and the client terminal based on the log information from the network logger.

Further, the server controller 810 may determine the state (e.g., playing timing, duration, resolution, or sound quality of multimedia data) of a data segment to be transmitted to the client terminal based on at least one of the total capacity or remaining capacity of the memory of the client terminal or the maximum resolution at which the client terminal may execute.

Further, the server controller 810 may determine the state of the data segment to be transmitted to the client terminal depending on whether the connection means between the streaming server 800 and the client terminal is wired communication or wireless communication. For example, the server controller 810 may determine the state of the data segment based on whether the client terminal is using a paid network offered from a carrier (e.g., KT, SKT, or LGT) or is in linkage with Wi-Fi. When the client terminal is in use of a carrier's paid network, the streaming server 800 may transmit data segments with a playable resolution to the client terminal without delay or buffering even at a transmission rate lower than the parameter value (e.g., data transmission rate) regarding the network environment between the streaming server and the client terminal, or may send data segments with the lowest resolution to the client terminal regardless of the conditions of the network environment.

FIG. 9 is a block diagram illustrating a client terminal according to an embodiment of the disclosure.

Referring to FIG. 9, a client terminal 900 includes a terminal controller 910 (or at least one processor) and a terminal communication unit 920 (or communicator or transceiver).

The terminal controller 910 includes an interface unit 930, a playing unit 940, and a network monitoring unit 950. The terminal controller 910 may control or manage software or hardware executed on the client terminal 900 or execute at least one command for executing the functions of the client terminal 900. The terminal controller 910 may transmit, to the streaming server, information, e.g., HTTP information, about multimedia data to be played through an HTTP request.

The terminal communication unit 920 may receive multimedia data or a data segment from the streaming server.

The terminal controller 910 may calculate a parameter value regarding the network environment between the streaming server and the client terminal 900 when the multimedia data or data segment is transmitted to the terminal communication unit 920, and send a request for at least one multimedia data item, that it is to receive, to the streaming server based on the calculated parameter value. The terminal communication unit 920 may further receive multimedia data or a data segment according to the request from the streaming server.

The playing unit 940 plays media (e.g., video) using data segments (e.g., video data segments). The playing unit 940 may include a decoder and an application buffer.

The client terminal 900 may further include a decoder unit (not shown). The decoder unit may decode the data segment received from the streaming server so that the data segment is converted to be output on an actual screen.

The client terminal 900 may further include a reordering unit (not shown). The reordering unit may combine, in order, data segments (e.g., video data segments) received from multiple wireless networks and transmit the combined data segments to the application buffer of the media player.

The network monitoring unit 950 may monitor the network environment based on the difference between when the multimedia data is sent from the streaming server and the time when the multimedia data is received by the client terminal 900, and the network monitoring unit 950 may send a request for a different data segment to the streaming server based on a result of monitoring the network environment.

Additionally, the network monitoring unit 950 may determine the network environment based on whether a delay or buffering occurs in playing the multimedia data requested by the user to be played. Further, the client terminal 900 may send a request for a different data segment to the streaming server based on whether the play of the multimedia data is delayed. Further, where the play of the multimedia data is delayed, the client terminal 900 may produce an alarm signal to be displayed to the user through the UI. For example, the alarm signal may include a warning indicating that it is requested to play multimedia data with a higher resolution as compared with the network environment and thus, a delay occurs or a guide to request that multimedia data with a lower resolution be played.

The client terminal 900 may further include a display unit (not shown) that receives decoding data from the decoder of the playing unit and outputs on an actual screen.

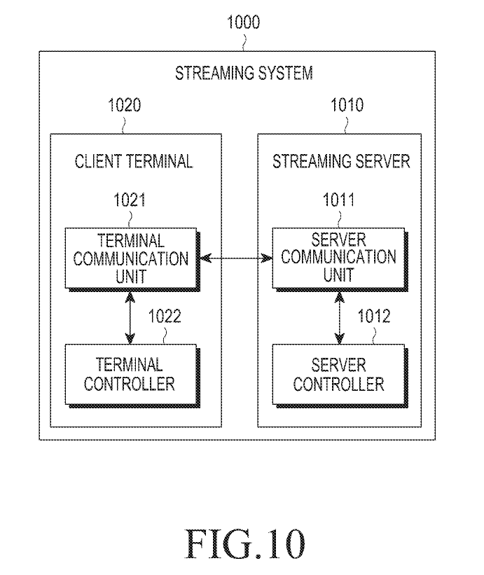

FIG. 10 is a block diagram illustrating a streaming system according to an embodiment of the disclosure.

Referring to FIGS. 8 to 10, according to the present disclosure, a streaming system 1000 providing HTTP adaptive streaming includes a streaming server 1010 and a client terminal 1020. The streaming server 1010 includes a server communication unit 1011 (or communicator or transceiver) and a server controller 1012 (or at least one processor). The client terminal 1020 includes a terminal communication unit 1021 (or communicator or transceiver) and a terminal controller 1022 (or at least one processor).

The streaming server 1010 may be the streaming server 800 of FIG. 8, and the client terminal 1020 may be the client terminal 900 of FIG. 9. However, embodiments of the present disclosure are not limited thereto.

As an example, where the streaming server 1010 and the client terminal 1020 in the streaming system 1000, each, includes a network monitoring unit for monitoring the network environment as shown in FIGS. 8 and 9, the streaming system 1000 may overall be more loaded but with the higher accuracy associated with monitoring the network environment between the streaming server 1010 and the client terminal 1020.

As another example, where a network monitoring unit for monitoring the network environment is included only in the server controller 1012 of the streaming server 1010, this may advantageously reduce the load on the client terminal 1020 which is typically subject to limited resources.

The above-described operations may be realized by equipping a memory device retaining their corresponding codes in any component of the server or terminal device of the communication system. That is, the controller in the server or terminal device may execute the above-described operations by reading and running the program codes stored in the memory device by at least one processor or central processing unit (CPU).

As described herein, various components or modules in the server or terminal device may be operated using a hardware circuit, e.g., a complementary metal oxide semiconductor-based logic circuit, firmware, software, and/or using a hardware circuit such as a combination of hardware, firmware, and/or software embedded in a non-transitory, machine-readable medium. As an example, various electric structures and methods may be executed using electric circuits such as transistors, logic gates, or ASICs.

As is apparent from the foregoing description, according to the present disclosure, the server may monitor the network environment and provide streaming data that adaptively varies depending on the network environment without overloading the client terminal.

The present disclosure may monitor the network environment based on the difference between the start time of data transmission and the arrival time of an ACK and thus, become able to provide terminal-customized HTTP streaming services in a more precise way.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for providing, by a streaming server, hypertext transfer protocol (HTTP) adaptive streaming to a terminal, the method comprising:
transmitting a first multimedia data to the terminal;
monitoring a network environment between the streaming server and the terminal when the first multimedia data is transmitted to the terminal; and
pushing at least one second multimedia data based on the monitored network environment.

2. The method of claim 1, wherein the pushing of the at least one second multimedia data comprises:
transmitting the at least one second multimedia data to the terminal regardless of whether there is a request from the terminal after the streaming server transmits the first multimedia data to the terminal.

3. The method of claim 2, wherein the pushing of the at least one second multimedia data further comprises:
transmitting the at least one second multimedia data to the terminal at predetermined times.

4. The method of claim 3, wherein the predetermined times are determined based on at least one of the first multimedia data item, the number of the at least one second multimedia data item, or a playing duration.

5. The method of claim 1,
wherein the network environment indicates a transmission rate between the streaming server and the terminal, and
wherein the monitoring of the network environment comprises calculating the transmission rate based on a difference between a time of starting transmission of the first multimedia data and a time of ending the transmission of the first multimedia data item.

6. The method of claim 5, wherein the difference is determined as a difference between the time of starting the transmission of the first multimedia data and a time of receiving an acknowledgment (ACK) signal for the first multimedia data transmitted.

7. The method of claim 1,
wherein the first multimedia data includes at least one of video data or audio data split into segments, and
wherein the pushing of the at least one second multimedia data comprises transmitting the at least one second multimedia data with a resolution different from a resolution of the first multimedia data item.

8. The method of claim 7, wherein the pushing of the at least one second multimedia data further comprises transmitting the at least one second multimedia data with a resolution lower than the resolution of the first multimedia data when the calculated transmission rate is lower than a prior transmission rate.

9. The method of claim 7, wherein the pushing of the at least one second multimedia data further comprises transmitting the at least one second multimedia data with a resolution lower than the resolution of the first multimedia data when the calculated transmission rate is lower than a transmission rate corresponding to the resolution of the first multimedia data item.

10. A streaming server configured to provide HTTP adaptive streaming to a terminal, the streaming server comprising:
a transceiver; and
a processor configured to:
control the transceiver to transmit a first multimedia data to the terminal,
monitor a network environment between the streaming server and the terminal when the first multimedia data is transmitted to the terminal, and
control the transceiver to push at least one second multimedia data based on the network environment monitored.

11. The streaming server of claim 10, wherein, to push the at least one second multimedia data item, the processor is further configured to:
control the server communicator to transmit the at least one second multimedia data to the terminal regardless of whether there is a request from the terminal after the streaming server transmits the first multimedia data to the terminal.

12. The streaming server of claim 11, wherein the processor is further configured to control the server communicator to transmit the at least one second multimedia data to the terminal at predetermined times.

13. The streaming server of claim 12, wherein the predetermined times are determined based on at least one of the first multimedia data item, the number of the at least one second multimedia data item, or a playing duration.

14. The streaming server of claim 10,
wherein the network environment indicates a transmission rate between the streaming server and the terminal, and
wherein the processor is further configured to calculate the transmission rate based on a difference between a time of starting transmission of the first multimedia data and a time of ending the transmission of the first multimedia data item.

15. The streaming server of claim 14, wherein the difference is determined as a difference between the time of starting the transmission of the first multimedia data and a time of receiving an acknowledgment (ACK) signal for the first multimedia data transmitted.

16. The streaming server of claim 10,
wherein the first multimedia data includes at least one of video data or audio data split into segments, and
wherein the processor is further configured to control to push the at least one second multimedia data with a resolution different from a resolution of the first multimedia data item.

17. The streaming server of claim 16, wherein the processor is further configured to control to push the at least one second multimedia data with a resolution lower than the resolution of the first multimedia data when the calculated transmission rate is lower than a prior transmission rate.

18. The streaming server of claim 16, wherein the processor is further configured to control to push the at least one second multimedia data with a resolution lower than the resolution of the first multimedia data when the calculated transmission rate is lower than a transmission rate corresponding to the resolution of the first multimedia data item.

19. A terminal configured to receive hypertext transfer protocol (HTTP) adaptive streaming from a streaming server, the terminal comprising:
a transceiver; and
a processor configured to:
control the transceiver to receive a first multimedia data from the streaming server,
calculate a parameter value regarding a network environment between the streaming server and the terminal when the first multimedia data is transmitted to the terminal communicator, and
control the transceiver to transmit a request for at least one second multimedia data to be received by pushing to the streaming server based on the calculated parameter value.

20. The terminal of claim 19, wherein the parameter value is calculated based on a difference between a time when the first multimedia data is transmitted from the streaming server and a time when the first multimedia data is received by the terminal.
